(19) United States
(12) Patent Application Publication
(10) Pub. No.: US 2006/0128218 A1
(43) Pub. Date: Jun. 15, 2006

(54) Shielding cage

(76) Inventors: Gert Droesbeke, Geel (BE); Ronald Christiaan Weber, Vught (NL)

Correspondence Address: HARRINGTON & SMITH, LLP, 4 RESEARCH DRIVE, SHELTON, CT, 06484-6212, US

(21) Appl. No.: 10/539,914

(22) PCT Filed: Dec. 19, 2003
(86) PCT No.: PCT/EP03/51085

§ 371 Date: Nov. 14, 2005

(30) Foreign Application Priority Data
Dec. 20, 2002 (NL) 1022230
Jun. 12, 2003 (NL) 1023650

(51) Int. Cl. H01R 13/648

(52) U.S. Cl. 439/607

(57) ABSTRACT

The invention relates to a shielding cage determined by a plurality of walls and including one or more mounting tails for mounting the shielding cage to a circuit board. The shielding cage is a die-cast shielding cage and the mounting tails are integrated mounting tails of the die-cast shielding cage. Preferably the mounting tails are flexible mounting tails to provide relief for temperature induced forces.

The invention relates to a shielding cage determined by a plurality of walls and comprising one or more mounting tails for mounting said shielding cage to a circuit board.

U.S. Pat. No. 6,416,361 discloses a metal plate transceiver cage with compliant legs, needle eye legs and support legs. In mounting the cage to a printed circuit board (PCB) the compliant legs and needle eye legs are extended through corresponding holes defined in the PCB. The cage can be secured to the PCB with or without soldering. The support legs and central and rear legs serve as stand-offs, separating the cage from the PCB to facilitate accurate soldering.

A problem with the prior art shielding cages is that the freedom of shaping these cages is limited, since they are made from metal sheet. As an example the cage can not be provided with a structure, such as a thread, for reception of a screw of a mating cable connector. Mounting a cable connector by a metal sheet formed cage is often achieved by providing latches that clip on associated features of a cable connector. Another problem of the metal sheet shielding cages is lack of robustness.

It is an object of the invention to provide an improved shielding cage at least solving or reducing some of the problems of prior art shielding cages.

This object is achieved by providing a shielding cage that is characterized in that said shielding cage is a die-cast shielding cage, said mounting tails being integrated mounting tails of said die-cast shielding cage. By providing a cage that is formed in a die-casting process, more complex shapes can be implemented in the shielding cage, while the integral or integrated mounting tails provide the option to place the shielding cage onto the PCB in one step. Integrated mounting tails should be attached to the shielding cage before the cage is mounted to the PCB, while with integral mounting tails the cage and the tails are made in one piece. Since the shielding cage is die-cast the mounting tails can easily be formed as integral or integrated mounting tails of the shielding cage.

In a preferred embodiment of the invention the mounting tails of the shielding cages are flexible mounting tails. Since the shielding cage is a die-cast cage, e.g. made of a Zn-alloy, there may exist a difference in thermal expansion coefficient between the cage and the PCB. Depending on the way in which the case is mounted to the PCB, a shear stress or push/pull stress may develop between the cage and the PCB as a result of temperature variation. The flexible mounting tails have the advantage that relief is provided for the forces due to temperature variations, such that the mounting of the cage to the PCB is ensured. Metal sheet formed cages, as known from the prior art, are less susceptible to differences in thermal expansion coefficients, since these properties of the materials used for the cage and in the PCB are quite similar.

In an embodiment of the invention, the die-cast cage comprises a receiving structure integrating the mounting tails. As mentioned above, structures can be easily formed in the die-cast cage. It is noted that the mounting tails may be attached directly to the die-cast cage or indirectly, i.e. a metal strip is attached to the receiving structure while the metal strip comprises the mounting tails. The mounting tails are e.g. copper or copper alloy surface mount technology (SMT) tails. By having copper or copper alloy as a material for the. mounting tails, temperature variation induced forces are decreased, since thermal expansion coefficients of the mounting tails and the PCB are approximately equal.

In a preferred embodiment of the invention the shielding cage the mounting tails comprise elongated integral die-cast tails, such as pin-in-paste (PIP) or wave solder tails. The integral mounting tails have the advantage that they can be formed in a single step with the other features of the shielding cage. By having the die-cast mounting tails elongated, flexibility of the mounting tails is obtained.

In an embodiment of the invention, the walls comprise an insertion stop structure, preferably outside the region of said mounting tails. This insertion stop prevents the walls of the shielding cage to be in contact with the solder paste by providing a stand-off between the walls of the cover and the PCB and thus avoids the solder to flow onto the cage during heating (re-flow). The insertion stop structure itself is preferably located at the site that is not in contact with the paste.

In a preferred embodiment of the invention a recess is provided in the wail around at least one mounting tail. This recess prevents the solder to flow via the mounting tail onto the walls of the shielding cage, i.e. the recess acts as a dam to the solder.

In a preferred embodiment of the invention at least one of the walls comprises a positioning pillar. These pillars provide increased accuracy since they are. meant to be placed in non-plated through holes in which no solder agent is present.

In a preferred embodiment of the invention the shielding cage is a diecast shielding cage having integrated mounting tails. The cage is diecast of a material having a coefficient of thermal expansion similar to that of the substrate on which the cage is to be mounted. Diecast brass metal shielding cages are advantageous in that their thermal expansion coefficient is almost identical to the thermal expansion coefficient of the conventional glass/epoxy laminates sued to form PCBs. Thus no substantial stresses develop between the shielding cage by the heating in the reflow mounting process. Moreover diecast brass shielding cages are economically more efficient for high volume production. Preferably the diecast shielding cage only comprises a few integrated mounting tails, e.g. at or near the corners of the cage. Further the diecast shielding cage may comprise several extensions along the perimeter of the shielding cage and projecting towards the PCB. These extensions, which may be truncated, rest on or slightly above the PCB in the paste used for mounting the shielding cage on the PCB. The extensions have several advantages such as control of the paste during the mounting process and the avoidance of providing perforations in the PCB for mounting the shielding cage. Also this diecast shielding cage may have a solder dam for preventing solder to run onto the shielding cage while heating.

In a preferred embodiment of the invention the shielding cage is adapted for covering a header and comprises a structure adapted for receiving attachment means of a cable connector to be connected to said header. Such complicated structures can be easily formed in a die-cast cover.

It should be appreciated that the embodiments discussed above, or aspects thereof, can be combined.

It is noted that die-cast shielding cages as such are known. However, these die-cast shielding cages do not comprise integral mounting tails that facilitate easy one-step placement. Placement of these die-cast cages is performed using SMT metal springs that are previously placed on the PCB. These metal springs are expensive and require extra operations for placement, namely one for each spring and one for the die-cast cover after mounting of the springs.

The invention will be further illustrated with reference to the attached drawing, which shows a preferred embodiment according to the invention. It will be understood that the shielding cage according to the invention is not in any way restricted to this specific and preferred embodiment.

In the drawing

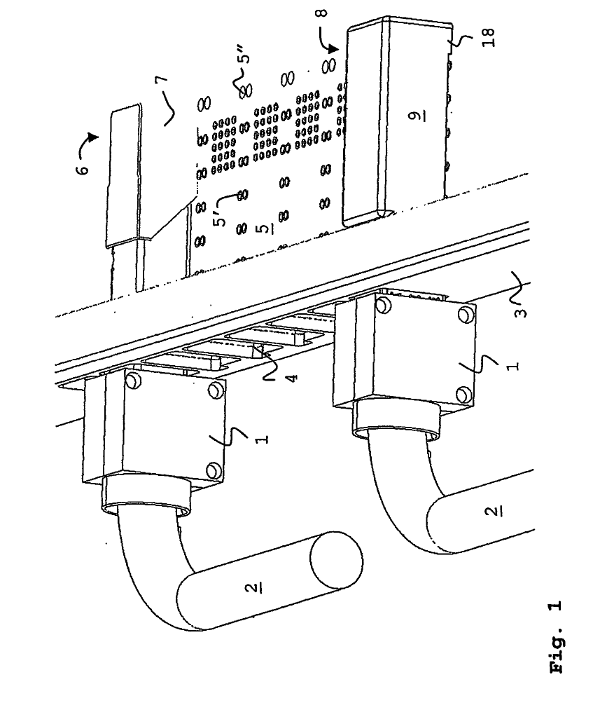

FIG. 1 shows two cable connectors connected to a circuit board with a shielding cage according to an embodiment of the invention;

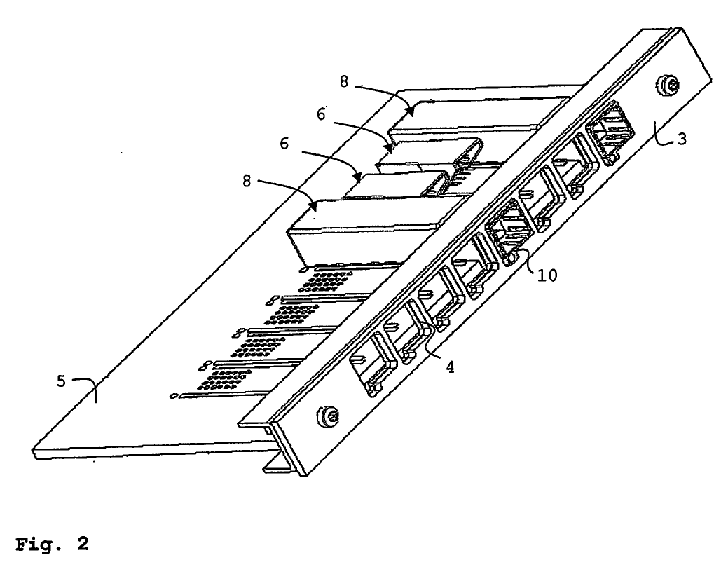

FIG. 2 shows a different view of a front panel with shielding cages according to an embodiment of the invention;

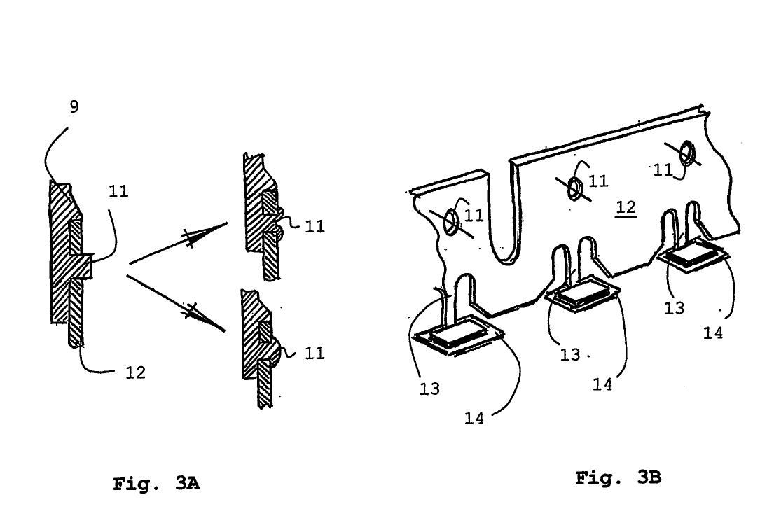

FIGS. 3A and 3B show a detailed part of a shielding cage according to a first embodiment of the invention;

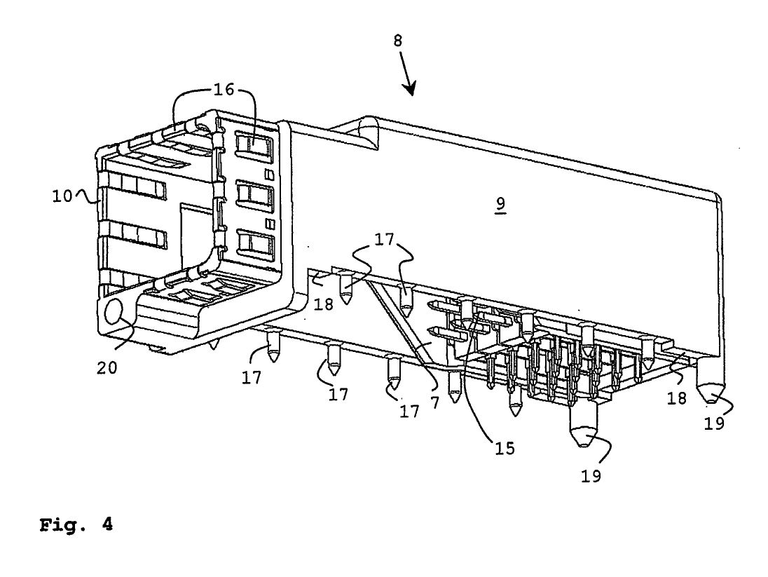

FIG. 4 shows a shielding cage according to a second embodiment of the invention;

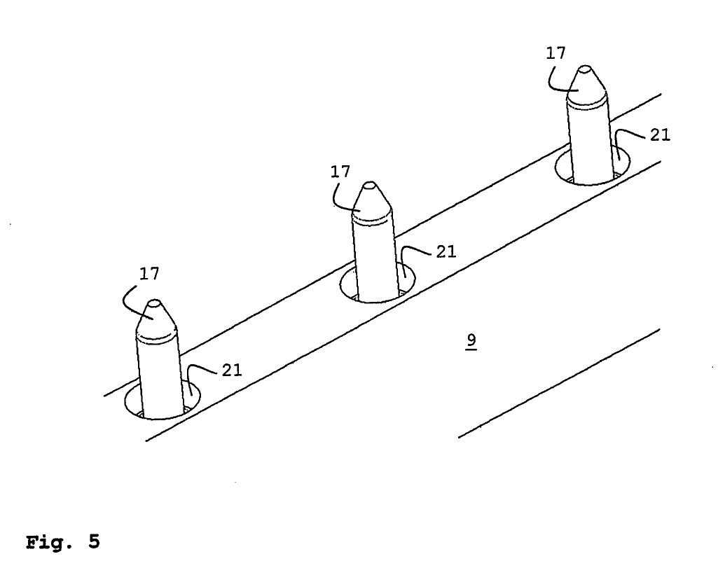

FIG. 5 shows a detailed part of a shielding cage according to a third embodiment of the invention;

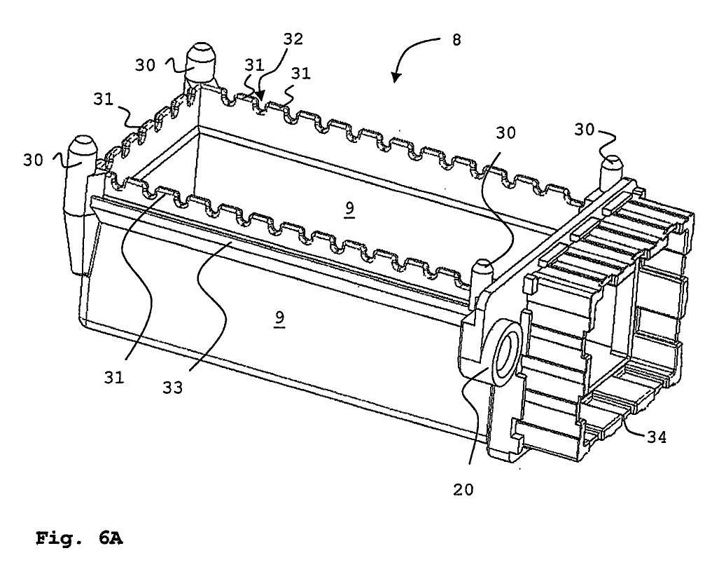

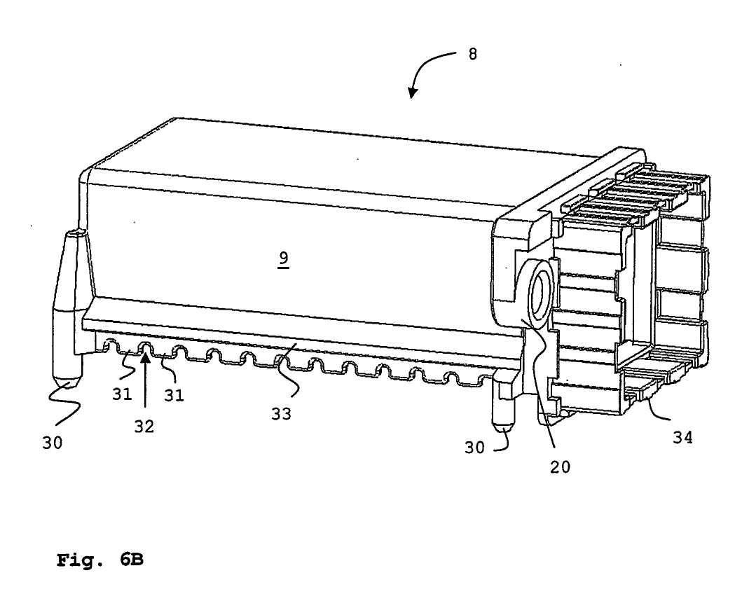

FIGS. 6A and 6B show a shielding cage according to a fourth embodiment of the invention.

In FIG. 1 a connector system is shown comprising a cable connector 1 for a cable 2 attached to a front panel 3 having openings 4 for insertion of the cable connector 1. The cable connector 1 is subject of a co-pending patent application (“Cable connector and method of assembling a cable to such a cable connector”) of the applicant of the same date. The front panel 3 comprises a circuit board 5, hereinafter also referred to as the PCB 5. The PCB 5 generally comprises a plurality of signal tracks and electrical components (not shown) for the transmittal of electrical signals to or from one or more wires of the cable 2. Connections of these wires to the signal tracks of the PCB 5 are obtained by providing a header arrangement comprising a header 15 (shown in FIG. 4) out of overmolded conductive lead frames with vertical-shields, held and positioned with a retainer structure 6. Retainer structure 6 comprises side walls 7 facilitating guiding of the cable connector 1 to the header. The PCB 5 further comprises die-cast shielding cages 8 with walls 9 mounted to the PCB 5 covering a header arrangement. PCB 5 also has pre-formed holes 5′ and 5″ for placing and mounting of a shielding cage 8.

FIG. 2 shows a different view of a front panel 3 without cable connectors 1 and with die-cast shielding cages 8. As illustrated, front parts 10 of the die-cast shielding cage 8 protrude from the openings 4 in the front panel 3. Details of various embodiments of the die-cast shielding cages 8 will be described next.

FIGS. 3A and 3B show a details of a first embodiment of a die-cast shielding cage 8 according to the invention. A wall 9 of a die-cast cage 8 comprises a-receiving structure 11 cast on the wall 8. The receiving structure 11 is adapted-to integrate a metal strip 12. The metal strip 12 is formed to have mounting tails 13 adapted to mount the shielding cage 8 to the PCB 5. The shielding cage 8 thus comprises integrated mounting tails 13. It should be appreciated that the mounting tails 13 may also be integrated directly, i.e. without a metal strip 12, to the wall 9 of the shielding cage 8. Moreover the metal strip 12 and/or the mounting tails 13 can be integrated by various means of attachment. In FIGS. 3A and 3B the metal strip 12 is riveted to the wall 9. However, other means of attachment include casting-in, punching or clipping the metal strip 12 or mounting tail 13 to the shielding cage 8. It is further noted that the mounting tails 13 may be bent to provide a larger solder surface to mount the shielding cage 8 to the solder foots 14 of the PCB 5.

The metal strip 12 preferably is made of copper or copper alloy and the mounting tails 13 are sheet metal SMT tails. In SMT, the PCB 5 is provided with a paste and the shielding cage 8 is placed on the PCB 5 such that the mounting tails 13 are positioned on the solder foots 14. Subsequently heating, also referred to as re-flow, is performed such that the mounting tails are soldered to the solder foots 14 using the paste as solder agent. The mounting tails 13 are flexible to provide relief for shear stresses developing as a result of the difference in thermal expansion coefficient between the PCB 5 and the die-cast shielding cage 8. A typical thermal expansion coefficient of a Zn-alloy die-cast shielding cage 8 is 2.67×10⁻⁵ mm/mK while the 'thermal expansion of the PCB 5 and the copper and copper/tin parts of the PCB 5 is in the range of 1.4−1.9×10⁻⁵ mm/mK. The flexible mounting tails 13 ensure that the solder joints between the mounting tails 13 and the PCB 13 are not over-stressed.

In FIG. 4 a second embodiment of a die-cast shielding cage 8 according to the invention is shown. In the shielding cage 8 the walls 7.of the retainer structure 6 is shown and a header 15. The header 15 comprises various pins for connecting with connecting means of the cable connector 1. The die-cast shielding cage 8 further comprises the front part 10 protruding from the opening 4 in the front panel 3 (shown in FIG. 2). In front part 10 various springs 16 are applied adapted to contact the metal housing of the cable connector 1 and to front panel 3 to provide continuous shielding.

The die-cast shielding cage 8 comprises various integral die-cast mounting tails 17 for mounting the shielding cage 8 to the PCB 5. The mounting tails 17 preferably are pin-in-paste (PIP), or otherwise wave solder mounting tails. In a PIP-process, first a paste is applied on the PCB 5 as in SMT. Subsequently the shielding cage 8 is placed on the PCB 5, such that the mounting tails 17 are positioned in plated-through holes 5′ (see FIG. 1) of the PCB 5, in contrast to the SMT-process wherein the tails rest on the PCB 5. Holes 5′ e.g. have a diameter of 0.9 mm. Next re-flow is performed such that the paste fills the holes 5′ around the inserted mounting tails 17 and acts as a solder agent for mounting the shielding cage 8 to the PCB 5. Flexibility of the mounting tails 17 is obtained by having them elongated to a length of e.g. five time the diameter of the mounting tails. The diameter of the mounting tails 17 is e.g. 0.65 mm. The mounting tails are applied at a pitch of e.g. 4.5 mm. However, the pitch of the mounting tails 17 may also be varied, e.g. by increasing the density of mounting tails 17 towards the front 10 of the shielding cage 8. The elongated mounting tails 17 and the paste in the holes 5′ provide sufficient flexibility for relief of the push/pull forces developing as a result of different thermal expansion coefficients if temperature changes. A typical range of use for temperature variation −40 to +70 degrees Celsius.

Other elements of the shielding cage 8 according to the invention include the insertion stop structure 18 and the positioning pillars 19. The insertion stop 18 avoids that the walls 9 of the shielding cage 8 are ‘dipped’ in the paste when the shielding cage 8 is mounted to the PCB. As a result a stand-off is created between the walls 9 and the PCB 5 such that the solder will not flow on the walls during re-flow but will flow into the gap between the plated through holes and the PIP or wave solder tails 17. As illustrated the insertion stop structures 18 are located outside the region of the mounting tails 17. The positioning pillars 19 provide guidance when placing the shielding cage 8 on the PCB 5, using holes 5″ (see FIG. 1). Holes 5″ are non-plated through holes and contain no solder agent or metal deposition as a result of which alignment of the positioning pillars 19 with the holes 5″ provides increased accuracy.

Moreover the front part 10 of the shielding cage 8 comprises a structure 20 for receiving fastening means (not shown) of the cable connector 1. This structure 20 may be complex, such as a threaded part, since the cage 8 is die-cast. A specific arrangement for such a complex structure 20 is subject of a co-pending application of the applicant.

In FIG. 5 a portion of an edge of a wall 9 of the shielding cage 8 shown in FIG. 4 is displayed. The wall comprises PIP-mounting tails 17 surrounded by a recess 21. Recesses 21 are applied to avoid the paste to run via the mounting tails 17 to the shielding cage 8 during re-flow and furthermore to increase the flexibility of the mounting tails 17.

FIGS. 6A and 6B show a diecast brass shielding cage 8 determined by a by a plurality of walls 9 and four mounting tales 30 for mounting the cage 8 to a circuit board 5. The mounting tails 30 are integrated with the shielding cage 8. The mounting tails 30 may direct forces exerted on the cable connector 1 directly to the PCB 5.

The thermal expansion coefficient of the brass material of the shielding cage 8 nearly matches that of the PCB 5 mention above. For the diecast brass shielding cage 8 the thermal expansion coefficient yields 1.7×10⁻⁵ mm/mK. As a result no shear stresses or push/pull stresses develop between the cage 8 and the PCB 5. The mounting tails 30 therefore can be more solid and/or shorter than for the diecast zinc shielding cage shown in FIG. 4. The mounting tails 30 preferably have a diameter in the range of 1.5-2 mm. The length of the mounting tails 30 may be shorter than for the zinc diecast shielding cage of FIG. 4 which reduces the complexity of casting these tails 30. Also the amount of mounting tails 30 can be reduced because of this effect, resulting in the reduction of holes 5′ to be made in the PCB 5 for mounting.

Apart from the mounting tails 3, the brass shielding cage 8 comprises a plurality of truncated extensions 31 along the perimeter of the cage 8. When positioned on the PCB 5 (i.e. the mounting tails 30 are slit into their corresponding holes 5′) the truncated extensions 31 rest on the PCB 5 or just above the surface in the paste provided for mounting. Compared to a continuous edge, the extensions 31 enable control of the paste as this paste adheres to the extensions 31 due to the openings 32. The openings 32 between the extensions 31 should be kept minimal in dimension to avoid degradation of the electromagnetic shielding performance of the cage 8. The extensions 31 are distributed uniformly along three edges of the perimeter of the shielding cage 31 to maintain an adequate electromagnetic shielding. In this embodiment, the truncated extensions 31 can be used in place of the flexible pins of the embodiment of FIG. 4 because of the thermal expansion characteristics of the diecast brass.

The diecast brass shielding cage 8 exhibits a solder dam 33 to avoid running of solder up to the walls of the shielding cage 8 in the reflow process.

The diecast brass shielding cage 8 further exhibits corresponding features as the diecast'shielding cage shown in FIG. 4 such as one or more structures 20 for receiving fastening means (not shown) of the cable connector 1. This structure 20 may be complex, such as a threaded part, since the cage 8 is die-cast. It is noted that while in FIGS. 6A and 6B the structure 20 is a structure outside the shielding cage 8, the structure 20 can be integrated within the diecast brass shielding cage as well. Further the diecast brass shielding cage 8 comprises spring clamping elements 34 for accommodating various springs 16 as shown in FIG. 4 to contact the metal housing of the cable connector 1 and to front panel 3 to provide continuous shielding.

1. Shielding cage determined by a plurality of walls and comprising one or more mounting tails for mounting said shielding cage to a circuit board characterized in that
said shielding cage is a die-cast shielding cage, said mounting tails being integrated mounting tails of said die-cast shielding cage.

2. Shielding cage according to claim 1, wherein said mounting tails are flexible mounting tails.

3. Shielding cage according to claim 1, wherein said die-cast shielding cage comprises a receiving structure integrating said mounting tails.

4. Shielding cage according to claim 3, wherein said mounting tails are sheet metal SMT tails.

5. Shielding cage according to claim 1, wherein said mounting tails are elongated integral die-cast tails.

6. Shielding cage according to claim 5, wherein said elongated die-cast tails are PIP-tails or wave solder tails.

7. Shielding cage according to claims 1, wherein at least one of said walls comprises an insertion stop structure.

8. Shielding cage according to claim 7, wherein said insertion stop structure is provided outside the region of said mounting tails.

9. Shielding cage according to claim 1, wherein a recess surrounds at least one mounting tail.

10. Shielding cage according to claim 1, wherein at least one of said walls comprises at least one positioning pillar.

11. Shielding cage according to claim 1, wherein said shielding cage is made of a die-cast material having a thermal expansion coefficient substantially equal to the thermal expansion coefficient of the circuit board.

12. Shielding cage according to claim 11, wherein said die-cast material is brass.

13. Shielding cage according to claim 11, wherein said shielding cage comprises a plurality of extensions on one or more of said walls projecting towards said circuit board along a perimeter of said shielding cage.

14. Shielding cage according to claim 1, wherein said shielding cage is adapted for covering a header and comprises a structure adapted for receiving attachment means of a cable connector to be connected to said header.
